(19) United States
(12) Patent Application Publication
(10) Pub. No.: US 2024/0408686 A1
(43) Pub. Date: Dec. 12, 2024

(54) METHOD FOR BRAZE FILLER METAL PREPARATION

(71) Applicant: Honeywell Federal Manufacturing & Technologies, LLC, Kansas City, MO (US)

(72) Inventor: Lucas Charles Jaster, Kansas City, MO (US)

(21) Appl. No.: 18/331,357

(22) Filed: Jun. 8, 2023

(51) Int. Cl. B23K 1/005; B23K 1/20

(52) U.S. Cl. CPC B23K 1/0056; B23K 1/20

(57) ABSTRACT

A method for brazing to join a first object to a second object comprises: cutting a sheet of braze filler metal using a laser to form a joint filler, removing foreign objects from an upper surface and a lower surface of the joint filler, placing the joint filler in a joint space between the first object and the second object; and heating the joint filler to a melting point temperature for a period of time.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### BACKGROUND OF THE INVENTION

Brazing is a process utilized for joining two objects together. The joint material, or braze filler metal, is a metal or metal alloy that has a melt temperature which less than a melt temperature of both the objects to be joined. The braze filler metal is prepared to size for the joint and placed between the two objects where the joint should be positioned. The braze filler metal, and optionally the two objects, is heated to a temperature at which the braze filler metal melts, but the material(s) of the two objects does not melt. One drawback to this process is that, when melted, the braze filler metal flows, or oozes, out of the joint space and onto other surfaces of the two objects. This drawback leads to at least one additional preprocessing step of adding physical features, such as barriers, or stopoff coatings to one or both of the objects around the joint to prevent outflow and/or at least one postprocessing step of removing the added physical features or coatings or removing the outflowed braze filler metal.

### SUMMARY OF THE INVENTION

Embodiments of the current invention address one or more of the above-mentioned problems and provide a distinct advance in the art of brazing without having to add physical features or apply stopoff coatings to prevent, or at least reduce, outflow of the braze filler metal. One embodiment of the current invention provides a method for brazing to join a first object to a second object comprising: cutting a sheet of braze filler metal using a laser to form a joint filler; removing foreign objects from an upper surface and a lower surface of the joint filler; placing the joint filler in a joint space between the first object and the second object; and heating the joint filler to a melting point temperature for a period of time.

Another embodiment of the current invention provides a method for brazing to join a first object to a second object comprising: cutting a sheet of braze filler metal using a marking laser without a cover gas to form a joint filler which includes an oxide layer of a plurality of side edges; removing oxide from an upper surface and a lower surface of the joint filler; placing the joint filler in a joint space between the first object and the second object; and heating the joint filler to a melting point temperature for a period of time.

Another embodiment of the current invention provides brazed composite object comprising a first object, a second object, and a joint filler. The first object includes a first joint surface, and the second object includes a second joint surface. The joint filler is positioned between the first object and the second object and is in contact with the first joint surface and the second joint surface. The joint filler includes an oxide layer positioned on a plurality of outer surfaces thereof. The brazed composite object is produced by: cutting a sheet of braze filler metal using a laser to form a joint filler; removing foreign objects from an upper surface and a lower surface of the joint filler; placing the joint filler in a joint space between the first object and the second object; and heating the joint filler to a melting point temperature for a period of time.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a listing of at least a portion of the steps of a method, in accordance with various embodiments of the current invention, for a brazing process to join a first object to a second object;

FIG. 2 is a top perspective view of a sheet of braze filler metal being cut by a laser to form a joint filler;

FIG. 3 is a top perspective view of the joint filler, showing a layer of oxide on each side edge;

FIG. 4 is a side cross-sectional view of the joint filler cut along line 4-4 of FIG. 3, illustrating the oxide layer on the left and right side edges;

FIG. 5 is a top perspective view of the joint filler, after the non-oxide coating has been removed from the upper surface and the lower surface;

FIG. 6 is a side cross-sectional view of the joint filler cut along line 6-6 of FIG. 5, illustrating that the non-oxide coating is no longer present on each of the upper surface and the lower surface;

FIG. 7 is a top perspective view of the first object, the second object, and the joint filler aligned with one another in preparation for the brazing process;

FIG. 8 is a top perspective view of the first object, the second object, and the joint filler therebetween in a joint space receiving heat during the brazing process;

FIG. 9 is a top perspective view of a brazed composite object including the first object, the second object, and the joint filler;

FIG. 10 is a top perspective view of a sheet of braze filler metal being cut by a laser to form a joint filler, wherein an upper surface and a lower surface of the sheet are each covered with a coating;

FIG. 11 is a top perspective view of a second embodiment of the joint filler, showing the coating and a layer of oxide on each side edge; and

FIG. 12 is a side cross-sectional view of the joint filler cut along line 11-11 of FIG. 10, illustrating the coating on each of the upper surface and the lower surface and the oxide layer on the left and right side edges.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

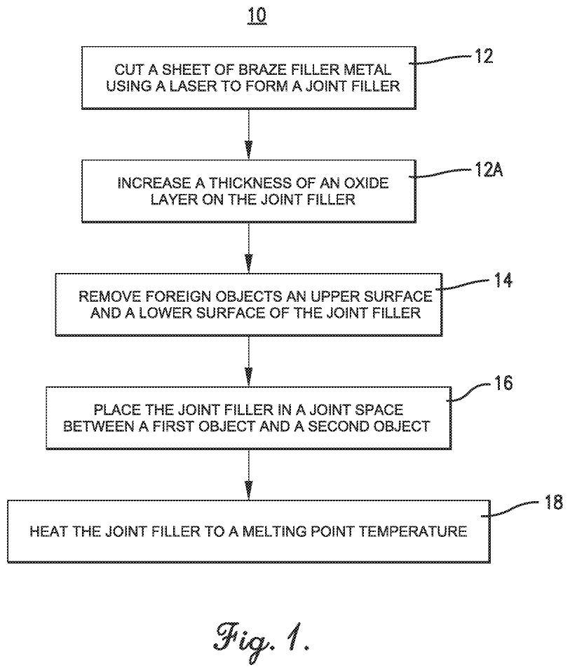

FIG. 1 depicts a listing of at least a portion of the steps of an exemplary method 10 for brazing to join a first object 100 to a second object 102. The steps may be performed in the order shown in FIG. 1, or they may be performed in a different order. Furthermore, some steps may be performed concurrently as opposed to sequentially. In addition, some steps may be optional or may not be performed.

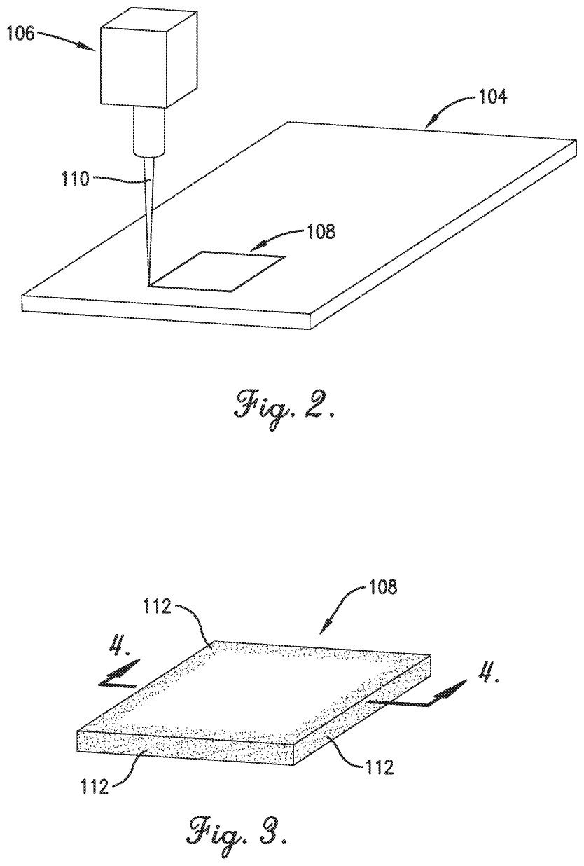

Referring to step 12 and FIG. 2, a sheet of braze filler material 104 is cut using a laser 106 to form a joint filler 108—the braze filler material 104 which joins the first object 100 and the second object 102. The braze filler material 104 may include any kind of metal or metal alloy, which is typically chosen to have a melt temperature that is less than a melt temperature of the materials of both the first object 100 and the second object 102. The braze filler material 104 is typically implemented or formed as a foil, with an upper surface and a lower surface, whose thickness is much less than a surface area of the sheet. Exemplary thicknesses of the sheet of braze filler material 104 range from approximately 1 mil to approximately 5 mils.

Referring to FIG. 10, in some embodiments, at least a portion of the upper surface and the lower surface of the sheet of braze filler material 104 are each covered with a coating 114 that includes tape, a high temperature paint, or other high temperature material which can be cut by the laser 106, but prevents, or minimizes, oxide growth on the upper surface and the lower surface.

The laser 106 may include any type of laser that generates a beam 110 configured to ablate material to provide a material marking function or a low power material cutting function—particularly metal or metal alloy marking or cutting. An exemplary embodiment of the laser 106 includes the PowerLine F series of fiber lasers manufactured by Rofin-Sinar Laser GmbH of Bergkirchen, Germany. Other options for the laser 106 include a CO₂ laser and the like.

To perform step 12 and with reference to FIGS. 2 and 10, the sheet of braze filler material 104 is placed on a table, a substrate, or a laser cutting base. The laser beam 110 is activated and follows a path that marks a perimeter of the joint filler 108. No cover gas, or other oxide prevention measures, with the laser 106 is used. The joint filler 108 may have any type of polygon shape, which generally corresponds to a shape of the surfaces of the first object 100 and the second object 102 that will be joined together. The perimeter shape of the exemplary joint filler 108 is a quadrilateral rectangle or square.

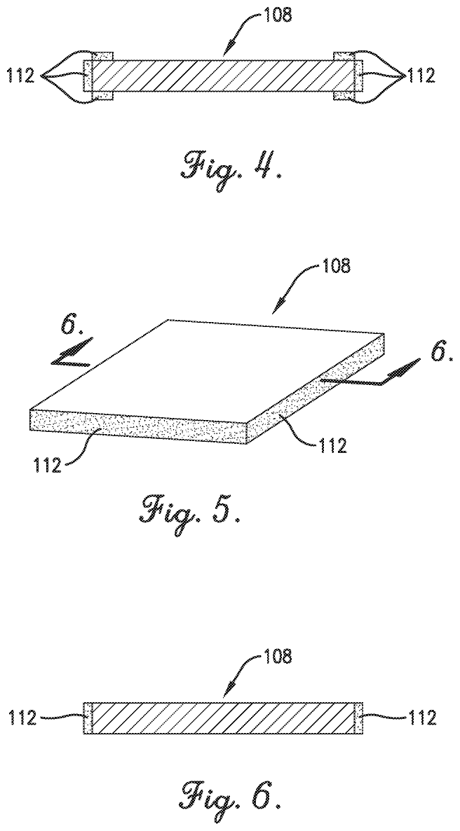

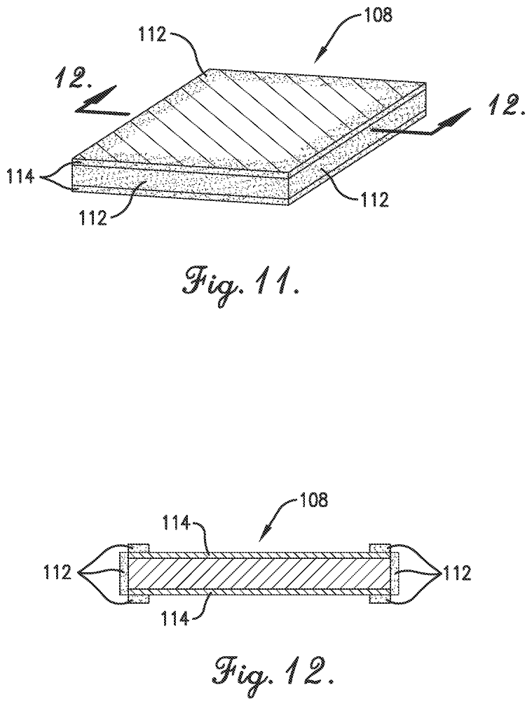

Referring to FIGS. 3 and 4, after the joint filler 108 is cut and removed from the sheet of braze filler material 104, each side edge of the joint filler 108 includes an oxide layer 112. In other words, the oxide layer 112 is formed by the cutting of the braze filler material 104 by the laser beam 110. In addition, portions of the upper surface and the lower surface which are adjacent to the side edges also include the oxide layer 112. Referring to FIGS. 11 and 12, if the upper surface and the lower surface of the sheet of braze filler material 104 were covered with the coating 114 prior to the cut, then a portion of the coating 114 may also include the oxide layer 112. The oxide layer 112 may have a thickness ranging from approximately 0.5 micrometers to approximately 1 micrometer. In some embodiments requiring precision, there may be benefit to decreasing the thickness of the oxide layer 112 to less than 0.5 micrometers. In such embodiments, the preferred thickness of the oxide layer 112 may range from approximately 0.1 micrometers to approximately 0.2 micrometers.

Referring to optional step 12A, in other embodiments, having the thickness of the oxide layer 112 be greater than 1 micrometer may be desirable. In such embodiments, the braze filler material 104 is cut with the laser beam 110 in the presence of an oxygen rich cover gas to promote oxide growth on the side edges of the joint filler 108. Similarly, other oxide increasing processing steps known to those skilled in the art (e.g., such as thermal oxidation at increased temperature, thermal sprays, defocused lasering, liquid/chemical treatments, plating) could be used to increase the thickness of the oxide layer 112.

Referring to step 14 and FIGS. 5 and 6, foreign objects are removed from the upper surface and the lower surface of the joint filler 108. The foreign objects include the oxide layer 112, as well as any other residuals or buildup. The foreign objects may be removed by sanding or other physical contact actions or by a plasma etching process to remove the outermost atomic layers of the upper surface and the lower surface of the joint filler 108. The foreign objects also include the coating 114. If the coating 114 includes tape or other pull-off adhesive, then the tape may be pulled off, or otherwise removed, and the upper surface and the lower surface of the joint filler 108 may be further cleaned or decontaminated as described above. If the coating 114 includes paint or similar material, then the upper surface and the lower surface of the joint filler 108 may be cleaned or decontaminated as described above.

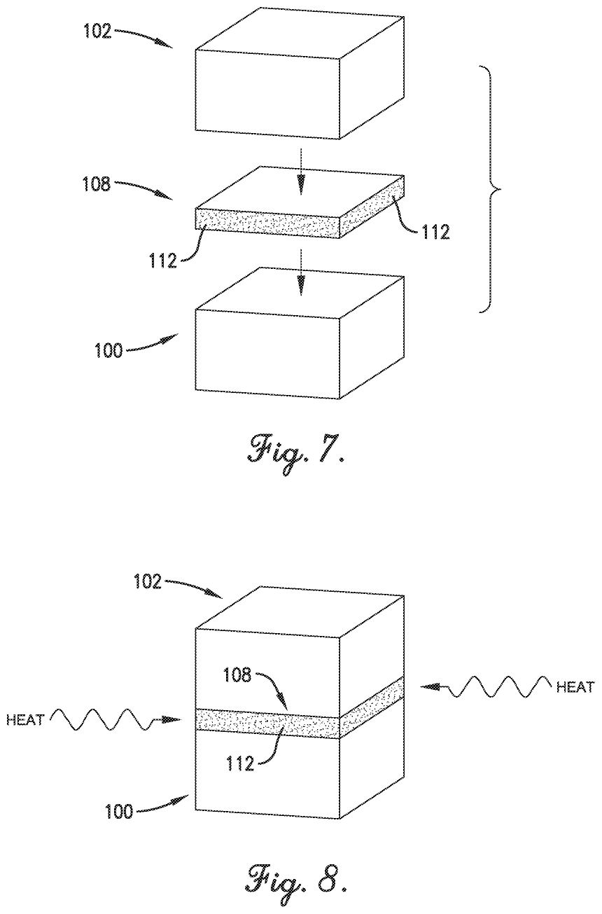

Referring to steps 16 and 18 and FIGS. 6 and 7, the joint filler 108 is positioned in a joint space between the first object 100 and the second object 102. Typically, the first object 100 is positioned such that its joint surface is facing upward. The joint filler 108 is placed on the first object 100 such that the lower surface of the joint filler 108 contacts the joint surface of the first object 100. The second object 102 is placed on the joint filler 108 such that the joint surface of the second object 102 contacts the upper surface of the joint filler 108. Heat is applied at least to the joint filler 108. In exemplary embodiments, the combination of the first object 100, the second object 102, and the joint filler 108 is placed in a vacuum furnace which heats all of the components to a temperature at which the joint filler 108 melts. In other embodiments, the joint filler 108 may be specifically targeted to receive the heat. After a period of time, the heat is removed at least from the joint filler 108. In exemplary embodiments, the combination of the first object 100, the second object 102, and the joint filler 108 is removed from the furnace. As the joint filler 108 cools, a solid joint, or connection, between the first object 100 and the second object 102 is formed. In addition, the presence of the oxide layer 112 on the outer (side) edges of the joint filler 108 during its heating and cooling prevents, or at least minimizes, any outflow or capillary action of the joint filler 108 material onto surfaces other the joint surfaces of the first object 100 and the second object 102.

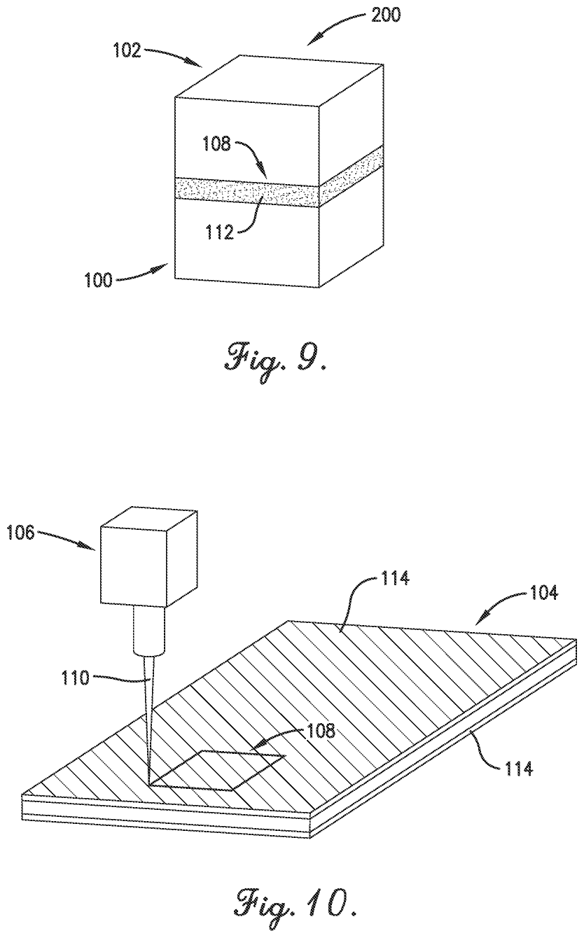

Referring to FIG. 9, implementation of the method 10 produces a brazed composite object 200 including the first object 100, the second object 102, the joint filler 108, and the oxide layer 112. The first object 100 and the second object 102 may be any two items to be joined together with a metallic joint. Each object 100, 102 includes a joint surface which contacts the joint filler 108. The joint filler 108 may include any kind of metal or metal alloy, which is typically chosen to have a melt temperature that is less than a melt temperature of the materials of both the first object 100 and the second object 102. The joint filler 108 is positioned between the first object 100 and the second object 102. The lower surface of the joint filler 108 contacts the joint surface of the first object 100, and the upper surface of the joint filler 108 contacts the joint surface of the second object 102. The oxide layer 112 is positioned on the exposed edges of the joint filler 108.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for brazing to join a first object to a second object comprising:
cutting a sheet of braze filler metal using a laser to form a joint filler;
removing foreign objects from an upper surface and a lower surface of the joint filler;
placing the joint filler in a joint space between the first object and the second object; and
heating the joint filler to a melting point temperature for a period of time.

2. The apparatus of claim 1, wherein the laser is a marking laser.

3. The apparatus of claim 1, wherein the laser is a fiber laser.

4. The apparatus of claim 1, wherein the laser is a CO₂ laser.

5. The apparatus of claim 1, wherein the laser is utilized without a cover gas.

6. The apparatus of claim 1, wherein an oxide layer forms on a plurality of side edges of the joint filler after cutting the sheet of braze filler metal using the laser.

7. The apparatus of claim 1, wherein removing foreign objects from the upper surface and the lower surface of the joint filler includes removing oxide from the upper surface and the lower surface.

8. The apparatus of claim 1, wherein removing foreign objects from the upper surface and the lower surface of the joint filler includes removing a coating from the upper surface and the lower surface.

9. A method for brazing to join a first object to a second object comprising:
cutting a sheet of braze filler metal using a marking laser without a cover gas to form a joint filler which includes an oxide layer of a plurality of side edges;
removing oxide from an upper surface and a lower surface of the joint filler;
placing the joint filler in a joint space between the first object and the second object; and
heating the joint filler to a melting point temperature for a period of time.

10. A brazed composite object comprising:
a first object including a first joint surface;
a second object including a second joint surface; and
a joint filler positioned between the first object and the second object and in contact with the first joint surface and the second joint surface, the joint filler including an oxide layer positioned on a plurality of outer surfaces thereof;
wherein the brazed composite object is produced by:
cutting a sheet of braze filler metal using a laser to form a joint filler;
removing foreign objects from an upper surface and a lower surface of the joint filler;
placing the joint filler in a joint space between the first object and the second object; and
heating the joint filler to a melting point temperature for a period of time.

11. The brazed composite object of claim 10, wherein the joint filler is formed from a metal or metal alloy that has a melt temperature that is less than a melt temperature of materials of both the first object and the second object.
